(19) United States
(12) Patent Application Publication
(10) Pub. No.: US 2006/0224504 A1
(43) Pub. Date: Oct. 5, 2006

(54) Mobile biometric merchant transaction processing

(75) Inventors: Kingsley Chuckwudum Nwosu, Union, PA (US); Daniel Chuckwudum Nwosu, Newark, NJ (US)

Correspondence Address: Ashok Tankha;Lipton Weinberger & Husick, 36 Greenleigh Drive, Sewell, NJ, 08080, US

(73) Assignee: Enenia Biometrics, Inc, Union, NJ (US)

(21) Appl. No.: 11/095,991

(22) Filed: Mar. 31, 2005

(51) Int. Cl. G06Q 40/00; G06Q 99/00; H04L 9/00; H04K 1/00

(52) U.S. Cl. 705/39; 705/67

(57) ABSTRACT

A method and system to enable mobile merchants process transaction payments. The system uses a BID card, smart device, merchant device, smart card reader scanner writer, and RFID reader. The BID card or smart device holds a merchant or non-merchant's personal, account, and biometric information. The merchant device contains one or more smart cards slots for inserting the BID cards; wireless and/or wire-line communicating interfaces and channels for plugging in a smart device and communicating with the remote backend host; and fingerprint scanning area for obtaining live fingerprint templates. The smart card reader write is an integrated device for reading from and writing to BID cards, also for obtaining live fingerprint templates. The smart card reader scanner writer is used in a banking institution when merchant or non-merchant needs to load money into his or her pre-paid account; and the RFID reader is used for communication between a smart device and host application on a personal computer.

### BACKGROUND OF THE INVENTION

This invention relates to a method, apparatus and system for enabling merchants and their customers to process payments using mobile biometric devices. In particular, it relates to automatic authentication of customers and merchants using their biometric profile, and electronic processing of transaction payments using bank and/or credit card accounts.

In developing and underdeveloped countries, due in part to a lack of business infrastructure such as commercial buildings, offices and stores, merchants often conduct buy-sell transactions with customers on the “fly”, i.e., in unconventional, unstructured or non-office locations when a business opportunity presents itself. For example, in such countries, buy-sell business transactions are commonly conducted on a street corner, in an open market, at a customer's residence, etc. Furthermore, in these economies, merchants rely on cash-based transactions for most transactions due to the absence of efficient and reliable electronic banking systems and lack of reliable means for authenticating the identification of merchants and customers. Even where electronic banking is available, customers have to withdraw cash from the banking systems in order to pay for their transactions with cash. This over reliance on cash-based transactions promotes fraudulent and criminal activities since there is always a high probability that an individual is carrying a large amount of money at any given time.

In developed economies where electronic transactions are pervasive, the mobile merchant transaction system disclosed in this invention allows mobile merchants, for example street hawkers, taxi drivers, merchants that deliver products or services to a residence, etc., to conduct secure financial transactions at any place including non-business locations.

### BRIEF DESCRIPTIONS OF THE DRAWINGS

FIG. 1A illustrates a system used by a merchant to process a customer payment.

FIG. 1B illustrates the method for a customer to pay a merchant for his/her transaction.

FIG. 2A illustrates a system used by a merchant or non-merchant to deposit money into his/her pre-paid account.

FIG. 2B illustrates the method used by a customer to deposit money into his or her pre-paid account.

FIG. 3A and FIG. 3B are logic flow diagrams showing how a merchant processes a customer's payment for a transaction.

FIG. 4A, FIG. 4B and FIG. 4C are logic flow diagrams showing how a merchant or non-merchant deposits money into his or her pre-paid account.

### DETAILED DESCRIPTION OF THE INVENTION

This invention presents a software and hardware solution that enables mobile merchants and customers to process transaction payments.

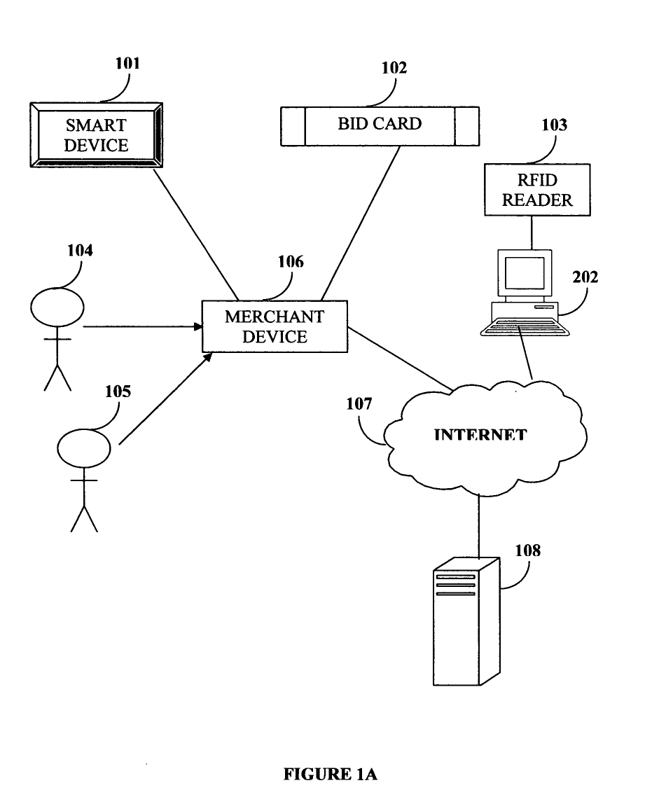

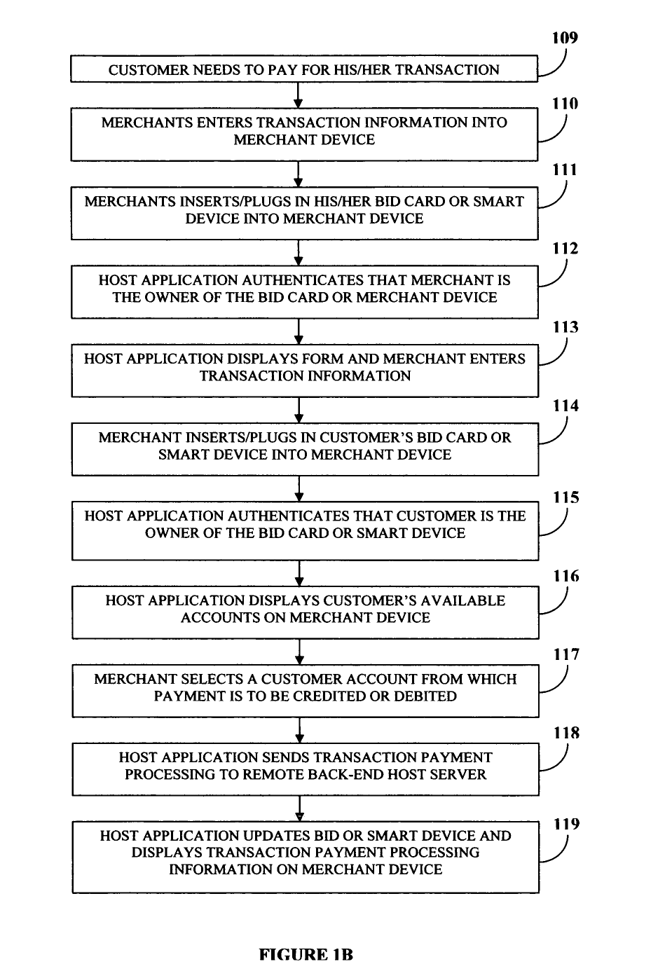

FIG. 1A describes a system used by a merchant to process a customer payment. The system comprises a hand-held owner-controlled integrated radio frequency identification (RFID) biometric mobile device hereinafter referred to as the smart device 101, a biometric identification (BID) card 102, a hand-held mobile biometric device hereinafter referred to as the merchant device 106, a radio frequency identification (RFID) reader 103, and a remote backend host server 108 to provide a solution for conducting secure, mobile financial transactions for the scenarios described above and for related scenarios.

The smart device 101 stores the following information of the owner: owner's biometric profile such as fingerprint templates; bank accounts information, for example, checking account, savings account, pre-paid account, etc.; credit card accounts information for example Visa, Master Card, American Express, etc.; and, any other necessary personal information. The smart device 101 also contains a small light emitting diode (LED) and a depressible biometric scanning aperture. The smart device 101 communicates with a merchant device 106 via a radio frequency identification (RFID) reader 103 or wire-line interface.

The merchant device 106 is an integrated mobile device with one or more smart card slots, fingerprint scanner area, receipt printer, and multiple wireless and wire-line communication channels. When a merchant device 106 is equipped with dual smart card slots, one is designated for the merchant BID card or merchant smart device while the other is designated for the customer's BID card or customer's smart device. The merchant device 106 includes a display for displaying transaction information to the customer or merchant. The merchant device 106 is powered by one or more rechargeable batteries or electric power.

The software application running on a merchant device 106 that communicates with the RFID reader 103 or smart device 101 is hereinafter referred to as the host application. The host application performs read-write operations on the biometric identification card 102 and the smart device 101. The host application communicates with the back-end host server 108 and processes the transaction between the customer and the merchant.

The smart card 102 hereinafter referred to as the biometric identification (BID) card is used to store the following personal information for an individual: a set of fingerprint templates; photo image; bank accounts, for example, checking account, savings account, pre-paid account, etc.; and, credit card accounts, for example, Visa, Master Card, American Express, etc.

The fingerprint templates in the smart device 101 and BID card 102 are used to authenticate the identity of the BID card 102 holder and the smart device 101 holder respectively. Only one individual can be authenticated as the owner of the BID card 102 or smart device 101. Each issued BID card 102 or smart device 101 is identified for a merchant, or for a non-merchant. A non-merchant BID card 102 can only make payments, ie., debit transactions; whereas a merchant BID card allows both credit and debit transactions. A merchant device is issued to only merchant customers, that is, customers with merchant BID cards 102 or merchant smart devices 101.

A customer is an individual who has a BID card 102 or smart device 101. A customer may be a merchant or non-merchant.

The utilization of this invention requires the implementation of the following three processes: enrollment of the merchants and non-merchants; transaction payment processing; and depositing money into a pre-paid account.

The enrollment process is the process by which a merchant or non-merchant obtains a BID card 102 or a smart device 101 and stores all the necessary personal and account information in it.

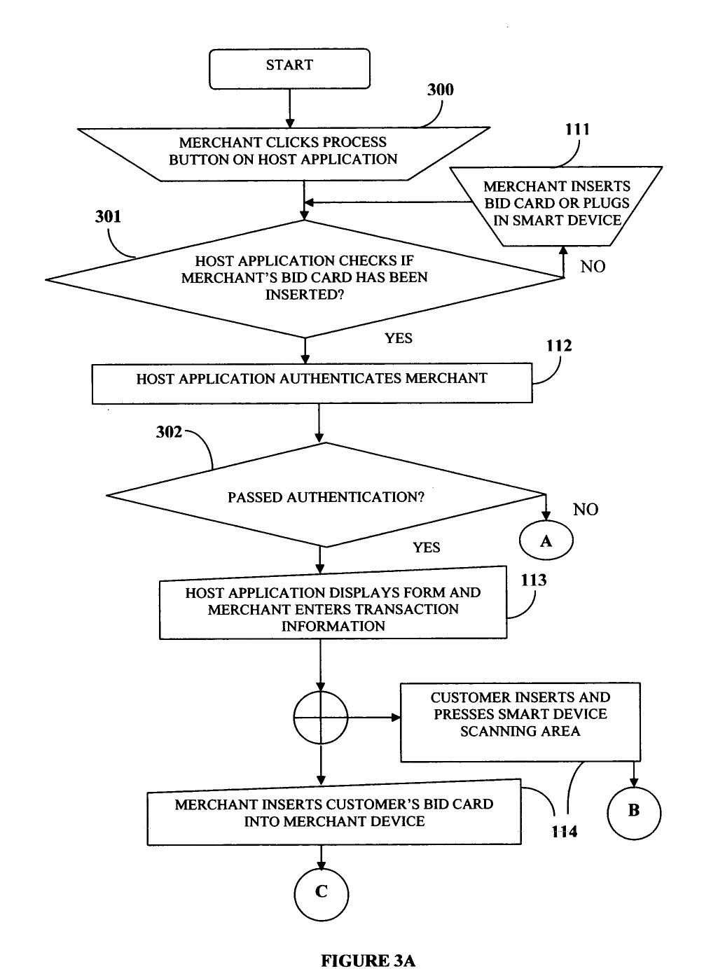

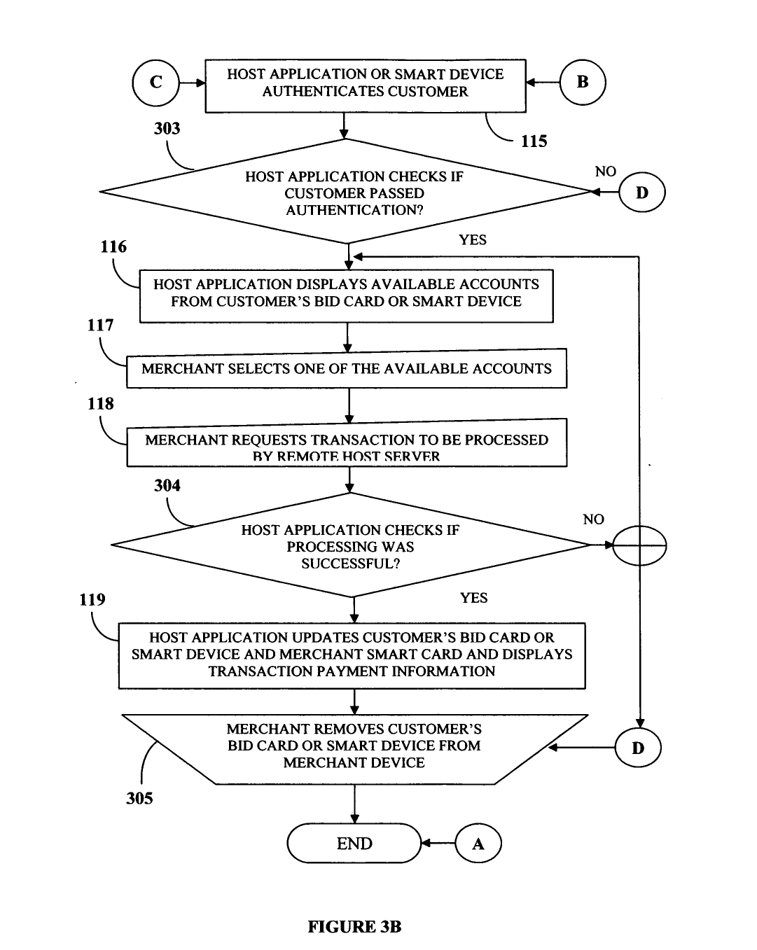

FIG. 1B, FIG. 3A and FIG. 3B illustrate how a customer pays a merchant for a transaction. In a typical business transaction, after a merchant and customer finalize the transaction and the customer 104 needs to pay for the transaction 109, the merchant 105 starts the host application 300 by clicking on a process button and enters the transaction information 110 into the host application running on the merchant device 106. The merchant then inserts his or her BID card 102 or plugs in his or her smart device 101 into the merchant device 111. The host application checks if the merchant has inserted his or her BID card 301 in the merchant device 111. The host application using the information in the BID card 102 or on the smart device 101 authenticates 302 that the merchant is the owner of the BID card or smart device 112. In order to authenticate and obtain information regarding the customer, the merchant inserts the customer's BID card 102 or plugs in the customer's smart device 101 into the merchant device 114. The host application using the information in the BID card 102 or authentication result from the smart device 101 determines 303 if the customer is the owner of the BID card 102 or smart device 115. The merchant device 106 communicates with the smart device 101 via wire-line communication. If the authentication 303 is successful, i.e., the host application indicates that the customer is the owner of the BID card 102 or smart device 101, the host application reads the customer's information from the customer's BID card 102 or smart device 101 and displays the available accounts of the customer on the merchant device 116. The merchant requests the customer to identify the account from which the payment is to be credited or debited. The merchant then selects the account from the list of accounts displayed 117 and submits the transaction for processing. The host application then formats the transaction payment information and transmits the information to the remote back-end host server 108 for processing 118. The merchant device 106 communicates with the remote back-end host server 108 via wired or wireless communication channels through the internet 107. If the transaction processing was successful 304, the result of the processing request is sent from the remote back-end host server to the merchant device 106. The host application then updates the account information in the remote host server 108 and BID card 102 or smart device 101 and displays 119 the payment processing result with transaction information on the merchant device 106. The merchant then removes the customer's BID card 102 or smart device 101 from the merchant device and returns it to the customer.

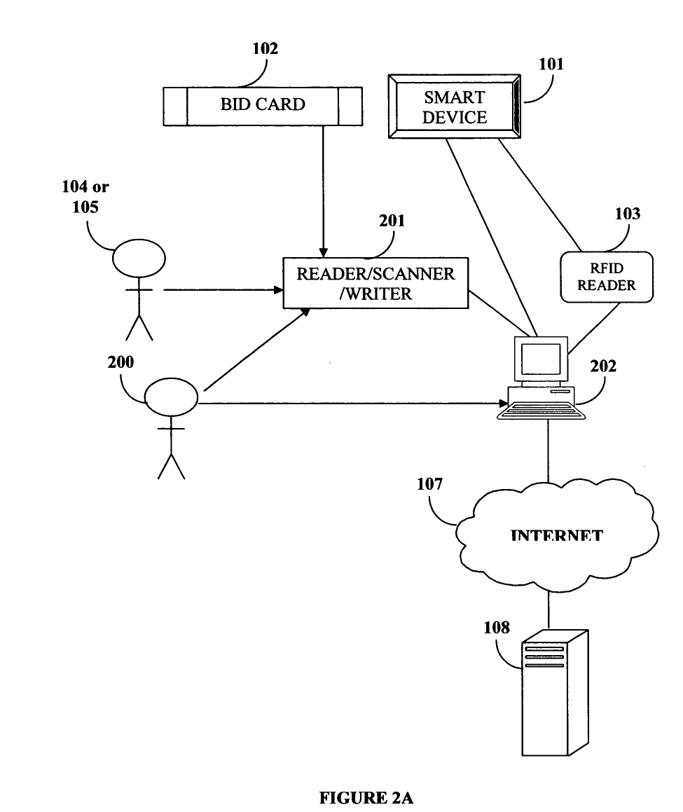

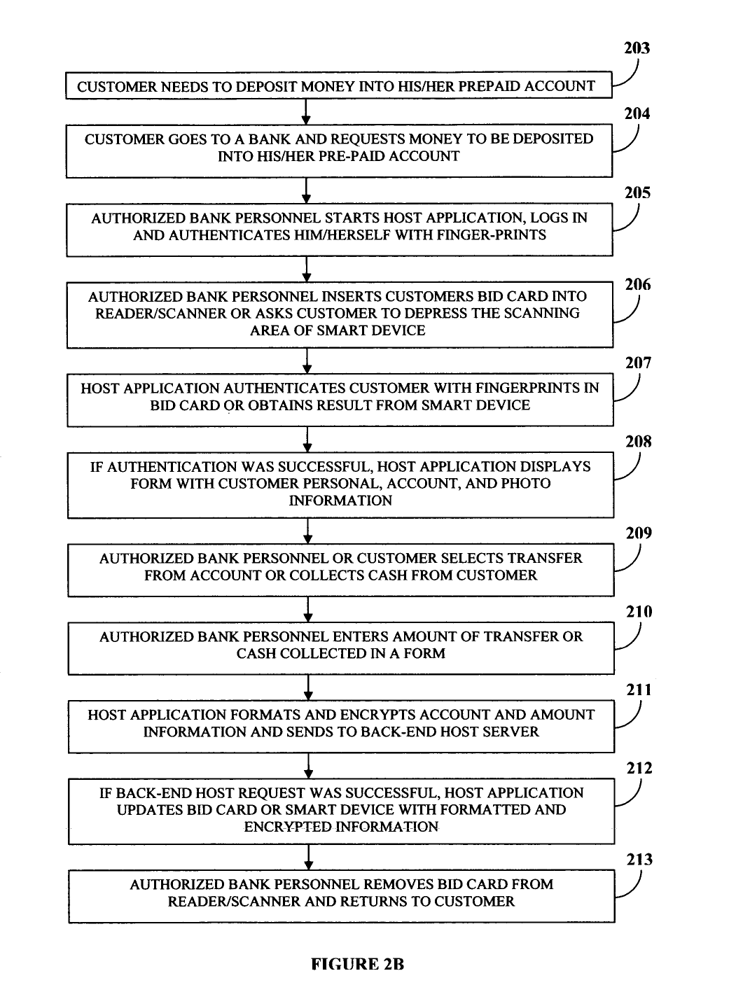

FIG. 2A illustrates a system used by a merchant or non-merchant to deposit money into his or her pre-paid account. The system includes a smart device 101, biometric identification cards 102, reader/scanner/writer 201, RFID reader 103, personal computer 202 and a back-end host server 108.

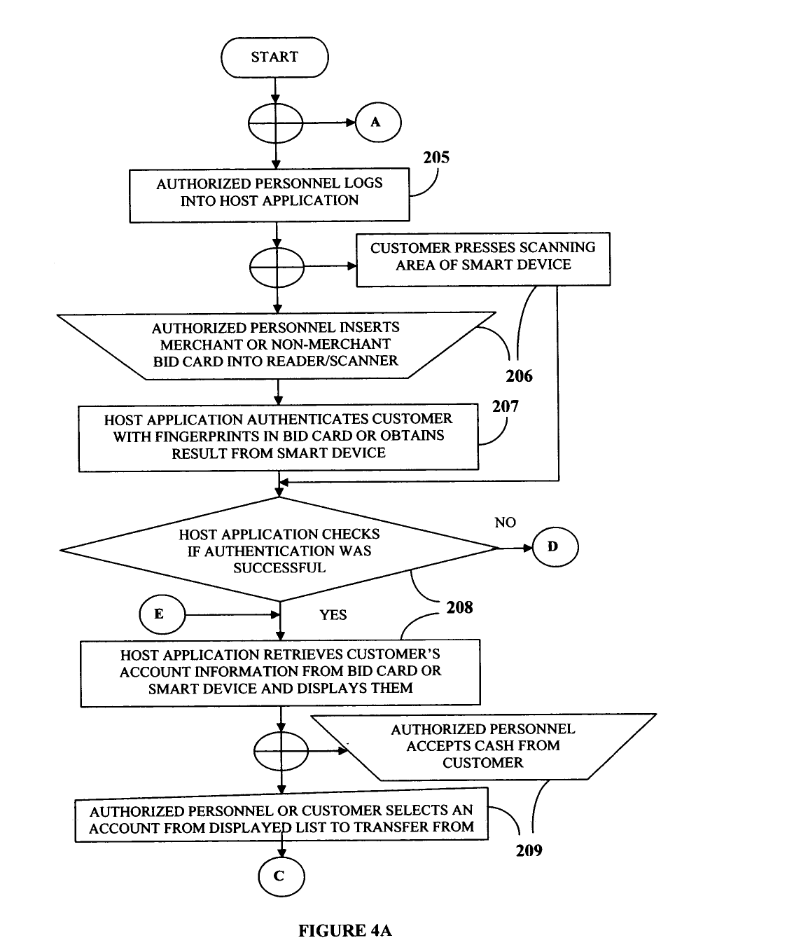

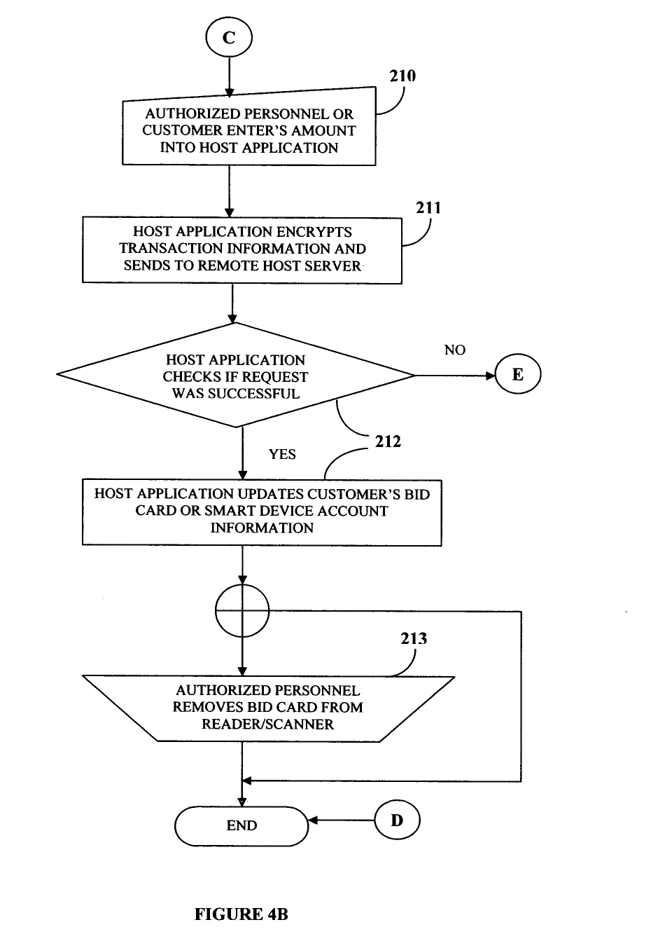

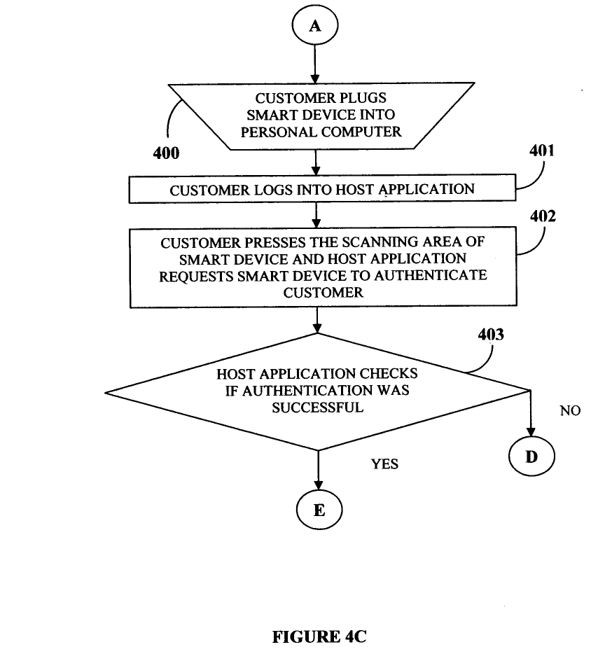

FIG. 2B, FIG. 4A, FIG. 4B, and FIG. 4C illustrate how the different components shown in FIG. 2A communicate with one another, and how a customer deposits money into his/her pre-paid account. When a merchant 105 or customer 104 needs to deposit money into his or her BID card 102 or smart device 101 prepaid account 203, the customer goes to any participating bank and requests an authorized bank personnel 200 to deposit a certain amount of money into his or her pre-paid account 204. The authorized bank personnel 200 starts the host application on a personal computer 202, logs in and authenticates himself or herself using their fingerprints 205. The authentication uses the fingerprint templates stored in the authorized personnel's BID card 102 or smart device 101. The BID card 102 is inserted into a fingerprint reader/scanner/writer 201. Following a successful login by the authorized bank personnel 200, the bank personnel inserts the customer's BID card 102 into the reader/scanner/writer 201 or asks the customer to depress 206 the scanning area of the smart device 101. The reader/scanner/writer 201 communicates with the personal computer 202 via a wire-line communication interface. The host application authenticates the customer by comparing the stored fingerprints in the customer's BID card against the customer's live fingerprints or obtains the authentication result 207 from the smart device 101. The host application communicates with the smart device 101 via the RFID reader 103. The RFID reader 103 communicates with the smart device 101 via the wireless communication channel. The RFID reader 103 communicates with the personal computer 202 via a wired communication interface. If the authentication was successful, the host application reads the account information from the customer's BID card 102 or smart device 101 and displays a form showing the customer's personal and account information 208. After the customer indicates the account that he/she wants the funds to be transfered from, the bank personnel selects the account or collects cash from the customer 209. The amount of transfer or cash collected is then entered 210 by the authorized bank personnel 200 into the form presented by the host application. Upon the request of the authorized bank personnel 200, the account and amount information are formatted and encrypted by the host application and sent to the remote back-end host server 108 for processing 211. The host application communicates with the remote back-end host server 108 via wired communication channel or wireless communication channel. If the request to the remote back-end host server 108 was successful, the host application updates the customer's BID card 102 or smart device 101 with formatted and encrypted information 212. The authorized bank personnel 200 then removes the customer's BID card 102 from reader/scanner/writer 201 and returns 213 the BID card to the customer.

In another embodiment of the invention illustrated in FIG. 4C, the merchant 105 or customer 104 can deposit money into his smart device 101 using a personal computer 202. The merchant or customer plugs 400 his or her smart device 101 into a personal computer. He or she then logs 401 into the host application as required by the host application. The customer presses the scanning area of the smart device 101 and the host application requests the smart device 101 to authenticate 402 the customer. The host application retrieves the authentication result from the smart device 101 and checks if the authentication was successful 403. If the authentication was successful, processing of the customer's transaction continues according to the logic described above.

The following example describes the method for a customer to pay for his/her transaction with a merchant. Mr. John Customer, the customer, purchases some items from Mr. Jim Merchant, a merchant. At the conclusion of the transaction, Mr. Customer decides to pay for the transaction from his checking account via his smart device. Mr. Merchant is not currently logged in the merchant device. Mr. Merchant inserts his BID card into the smart card slot of the merchant device and presses one of his fingerprints on the fingerprint scanner of the merchant device. The host application in the merchant device reads the scanned fingerprint templates and compares them against the stored fingerprint in Mr. Merchant's BID card. If the fingerprint templates match, the host application displays a form for Mr. Merchant to enter the transaction information. Mr. Merchant enters the transaction information including the transaction amount. Mr. Merchant then plugs Mr. Customer's smart device into the USB universal serial bus port interface of the merchant device. Mr. Merchant then asks Mr. Customer to press the fingerprint scanning area of the smart device. When Mr. Customer presses the scanning area of the smart device, the smart device scans the live fingerprint and compares it against Mr. Customer's stored fingerprint in the smart device. If the fingerprint templates match, the host application retrieves and displays to Mr. Merchant the available accounts of Mr. Customer. Mr. Merchant then selects the checking account of Mr. Customer and submits the transaction for processing. Upon successful processing, the transaction information and payment code are displayed by the host application.

Alternatively, if Mr. Customer has a BID card, then Mr. Merchant inserts his (Mr. Merchant's) BID card into the smart card slot of the merchant device and presses one of his fingerprints on the fingerprint scanner of the merchant device. The host application in the merchant device reads the scanned fingerprint templates and compares them with the stored fingerprints in Mr. Merchant's BID card. If the fingerprint templates match, the host application displays a form for the Mr. Merchant to enter the transaction information. Mr. Merchant enters the transaction information including the amount. Mr. Merchant then removes his BID card and inserts Mr. Customer's BID card. If the merchant device is equipped with dual smart card slots, then Mr. Merchant inserts Mr.

Customer's BID card into the customer slot of the merchant device. Mr. Merchant then requests Mr. Customer to press one of his/her fingerprints on the fingerprint scanner of the merchant device. When Mr. Customer presses the scanning area of the merchant device, the merchant device scans the live fingerprint and compares it with the stored one in Mr. Customer's BID card. If the fingerprint templates match, the host application retrieves and displays to Mr. Merchant the available accounts of Mr. Customer. Mr. Merchant then selects the checking account and submits the transaction. Upon successful processing, the transaction information and payment code are displayed by the host application.

The following example describes the method for a merchant or non-merchant to deposit money into his/her BID card or smart device. Mr. John Doe, a non-merchant with a smart device, desires to add more money to his pre-paid account by transferring $3,000.00 from his Bank of America's Visa card. Mr. Doe has a personal computer at home with internet access. Mr. Doe starts the host application on his personal computer at home, plugs in his smart device, presses the scanning area, and is authenticated. Upon successful authentication, the host application displays a form showing Mr. Doe's available accounts. Mr. Doe then selects the Bank of America's Visa card and enters the amount of $3,000.00. Upon request by Mr. Doe to transfer the money from the Visa account to the pre-paid account, the host application requests Mr. Doe to supply his fingerprints again. If the fingerprints match, the host application sends the transaction request to the remote back-end host. If the remote backend host processing is successful, then the pre-paid account in Mr. Doe's smart device is updated accordingly.

Alternatively, if Mr. Doe has a BID card but does not have a fingerprint reader/scanner/writer, he goes to a participating institution such as a bank. Upon arrival, Mr. Doe requests Mr. Washington, the authorized bank personnel that he desires to deposit money into his pre-paid account. Mr. Washington then starts the host application and logs in using his fingerprints. Mr. Washington then inserts Mr. Doe's BID card into the reader/scanner/ writer device and asks Mr. Doe to press the fingerprint scanning area of the device. If the authentication is successful, then the host application reads the BID card and displays Mr. Doe's available accounts. Mr. Washington then selects the Bank of America's Visa card account and enters the amount. Mr. Washington then enters the processing request in the host application. The host application sends the request to the remote back-end host server for processing. If the remote backend host processing is successful, Mr. Doe's BID card pre-paid account is updated accordingly.

What is claimed is:

1. A system for electronic payment and processing of a transaction between a merchant and a customer, comprising:
a merchant device, further comprising:
a fingerprint scanning component for scanning the fingerprints of a merchant or customer on said merchant device;
one or more reader writer slots for reading and writing to a smart device or biometric identification card;
wired and wireless communication interfaces for communicating with a smart device or biometric identification card;
wired communication interface for communicating with a radio frequency identification detection reader;
a host application that runs on said merchant device to read-write operations on the biometric identification card and the smart device; and
a display for displaying transaction information to the customer or merchant;
a biometric identification card that holds the customer's personal and account information in communication with the reader writer slot on said merchant device for performing the read and write operations;
a smart device that communicates with said merchant device via a radio frequency identification reader or a wire-line interface, further comprising:
a shared memory area that holds the personal and account information and
biometric profile of the owner of the smart device; and
an authentication module that authenticates that the holder of the smart device is the true owner of the smart device;
a radio frequency identification reader in communication with the smart device; and,
a remote back-end host server in wireless communication or internet communication with the merchant device for processing payment requests transmitted by the merchant device.

2. The system of claim 1, wherein the merchant device communicates with the smart device via a wire-line communication interface.

3. The system of claim 1, wherein the merchant device is provided with a first smart card slot and a second smart card slot, said first smart card slot dedicated for the merchant and said second smart card slot dedicated for the customer.

4. The system of claim 1, wherein the smart device is a mobile biometric device that performs biometric authentication and stores the result in the smart device.

5. The system of claim 1, wherein the transaction information is formatted and encrypted prior to transmission to the remote back-end host server.

6. The system of claim 5, wherein the encryption method uses public or private encryption algorithm.

7. The system of claim 1, wherein the merchant device communicates with the remote back-end host server via wired or wireless communication interface.

8. The system of claim 1, wherein the merchant has a pre-paid account.

9. A method for a customer to pay a merchant for a transaction comprising the use of a customer's biometric identification card, merchant's biometric identification card, merchant device and remote back-end host server comprising the steps of:
logging on to the host application to process a customer payment;
entering the transaction information by the merchant into a form displayed by the host application;
inserting the merchant's biometric identification card into the merchant device;
authenticating the merchant via the host application by comparing the live fingerprints of the merchant against the stored fingerprints in the biometric identification card;
removing the merchants biometric identification card and inserting the customer's biometric identification card into the merchant device, or inserting the customer's biometric identification card into the customer-designated smart card slot in the merchant device;
authenticating via the host application that the customer is the true owner of the customer biometric identification card by matching the customer's live fingerprint templates against the fingerprints stored in the customer's biometric identification card;
reading the customer's available account information from the biometric identification card from the host application and displaying said information on the merchant device;
selecting an available account as directed by the customer against which to process the payment;
processing the transaction via the host application by the merchant;
transmitting the payment information via the host application to the remote back-end host server;
processing the transaction by the back-end host server and returning the result to the host application;
updating the merchant and customer's biometric identification cards via the host application if the remote back-end host server processing was successful; and
displaying the transaction information and processed transaction on the merchant device via the host application.

10. The method of claim 9, wherein the customer must have at least one account in the biometric identification card.

11. The method of claim 9, wherein the merchant's and customer's biometric identification cards are updated only if the remote backend host server processing is successful.

12. A method for a customer to pay a merchant for a transaction comprising the use of a customer's smart device, host application, merchant's biometric identification card, and merchant device comprising the steps of:
logging on to the host application to process a customer payment;
entering the transaction information by the merchant into a form displayed by the host application;
inserting the merchants biometric identification card into the merchant device;
authenticating the merchant via the host application by comparing the live fingerprints of the merchant against the stored fingerprints in the biometric identification card;
plugging merchant device into customer's smart device via a wire-line communication interface;
authenticating via the host application that the customer is the true owner of the customer smart device by matching the live fingerprint templates against the fingerprint template stored in the smart device;
reading the customer's available account information by the host application from the smart device and displaying said information on the merchant device;
selecting an available account as directed by the customer against which to process the payment;
processing the transaction via the host application and sending the transaction information to the remote back-end host server;
processing the transaction by the remote back-end host server and returning the result to the host application;
updating the merchant's biometric identification card and customer's smart device by the host application if the remote back-end host processing is successful; and
displaying the transaction information and processed transaction by the host
application on the merchant device.

13. The method of claim 12, wherein the customer must have at least one account in the smart device.

14. The method of claim 12, wherein the merchant's biometric identification card and customer's smart device are updated only if the remote backend host processing is successful.

15. A method for a customer to pay a merchant for a transaction comprising a customer's biometric identification card, merchant's smart device, host application and merchant device comprising the steps of:
logging on to the host application to process a customer payment;
entering the transaction information by the merchant into a form displayed by the host application;
plugging merchant's smart device into the merchant device;
authenticating the merchant via the host application by comparing the live fingerprints of the merchant against the stored fingerprints in the smart device;
inserting the customer's biometric identification card into the merchant device;
authenticating via the host application that the customer is the true owner of the customer biometric identification card by matching the customer's live fingerprint against those stored in the customer's biometric identification card;
reading the customer's available account by the host application from the biometric identification card and displaying said information on the merchant device;
selecting an available account as directed by the customer against which to process the payment;
processing the transaction via the host application and sending the transaction information to the remote back-end host server;
processing the transaction by the remote back-end host server and returning the result to the host application;
updating the merchant's smart device and customer's biometric identification
card by the host application if the remote backend host processing was successful; and
displaying the transaction information and processed transaction on the merchant device by the host application.

16. The method of claim 15, wherein the customer must have at least one account in the smart device.

17. The method of claim 15, wherein the merchant's smart device and customer's biometric identification card are updated only if the remote back-end host processing is successful.

18. A method for a merchant or non-merchant to deposit money into his or her pre-paid account comprising a customer's biometric identification card, an authorized bank personnel, a smart card reader/scanner/writer, further comprising the steps of:
requesting an authorized bank personnel from a participating banking institution to deposit customer's money onto his or her pre-paid account;
starting and logging into the host application by the authorized bank personnel;
authenticating the authorized bank personnel using his/her fingerprints;
inserting the customer's biometric identification card into the smart card reader/scanner/writer and requesting the customer to provide his or her fingerprints;
obtaining the live fingerprint templates by the host application from the reader/scanner/writer and matching the customer's stored fingerprints from the biometric identification card;
terminating the process if the fingerprints do not match;
reading the biometric identification card by the host application and displaying the customer's personal and account information on the personal computer;
selecting the transfer of funds from customer's account by the bank personnel or collecting cash from the customer;
entering the transfer amount or collected amount on the host application by the authorized bank personnel;
formatting and encrypting the transaction information by the host application and sending the data to the remote back-end host server for processing; and
updating the customer's biometric identification card by the host application if the remote backend host processing was successful.

19. The method of claim 18, wherein the authorized bank personnel is authenticated against his/her fingerprint templates stored on his/her biometric identification card, or in a remote back-end host server.

20. The method of claim 18, wherein the customer must have a pre-paid account in his or her biometric identification card.

21. The method of claim 18, wherein the customer selects the account from which funds are transferred.

22. The method of claim 18, wherein the encryption method used is an open or private encryption algorithm.

23. The method of claim 18, wherein customer's biometric identification card is updated only if the remote back-end host server processing is successful.

24. A method for a merchant or non-merchant to deposit money into his or her pre-paid account using a customer's smart device, an authorized bank personnel and a RFID reader, comprising the steps of:
requesting an authorized bank personnel from a participating banking institution to transfer money into customer's pre-paid account;
starting and logging into the host application by the authorized bank personnel;
authenticating the authorized bank personnel using his or her fingerprints;
requesting the customer to provide his or her fingerprints by pressing fingerprint on the scanning area of the smart device;
authenticating the customer by comparing the live fingerprint templates of the customer against the fingerprints stored in the smart device;
storing the authentication result in a specially designated area of the smart device;
reading the authentication result from the smart device by the host application;
terminating the process by the host application if the authentication failed;
reading the smart device by the host application and displaying the customer's personal and account information on the personal computer;
selecting the transfer of funds from an account by the authorized bank personnel or collecting cash from the customer;
entering the transfer amount or collected amount on the host application by the authorized bank personnel;
formatting and encrypting the transaction information by the host application and sending the data to the remote back-end host server for processing; and
updating the customer's smart device by the host application if the remote back-end host server processing was successful.

25. The method of claim 24, wherein the authorized bank personnel is authenticated against his/her fingerprint templates on his/her biometric identification card, or in a remote host server.

26. The method of claim 24, wherein the customer must have a pre-paid account in his/her smart device.

27. The method of claim 24, wherein the customer selects the account from where the funds are transferred.

28. The method of claim 24, wherein the encryption method used is an open or private encryption algorithm.

29. The method of claim 24, wherein the customer's smart device is updated only if the remote back-end host server processing is successful.

30. A method for a merchant or non-merchant to deposit money into his/her pre-paid account comprising a customer's smart device and a personal computer, further comprising the steps of:
starting of the host application by the merchant or non-merchant and indicating that he/she wants to load money into his/her pre-paid account;
pressing merchant's or non-merchant's fingerprint on the scanning area of the smart device;
authenticating the merchant or non-merchant by comparing the live fingerprint templates with those stored in the smart device;
storing the authentication result in a specially designated area of the smart device by the smart device;
reading the authentication result from the smart device by the host application;
terminating the process by the host application if the authentication failed;
reading the smart device by the host application and displaying the customer's personal and account information on the personal computer;
selecting the transfer of funds from account by the merchant or non-merchant;
entering the transfer amount on the host application by the merchant or non-merchant;
formatting and encrypting the transaction information by the host application and sending the data to the remote backend host for processing; and
updating the customer's smart device by the host application if the remote backend host processing was successful.

31. The method of claim 30, wherein the merchant or non-merchant must have a pre-paid account and one or more bank accounts or credit card accounts.

32. The method of claim 30 wherein the merchant or non-merchant selects the account from where the funds are transferred.

33. The method of claim 30, wherein the encryption method used is based on open or private encryption algorithm.

34. The method of claim 30, wherein the merchant or non-merchant's smart device is updated only if the remote back-end host processing was successful.
